(19) United States
(12) Patent Application Publication
(10) Pub. No.: US 2026/0368004 A1
(43) Pub. Date: Nov. 19, 2026

(54) SERVERLESS MICROSERVICES FRAMEWORK

(71) Applicant: Oracle International Corporation, Redwood Shores, CA (US)

(72) Inventors: Sanjeeb Kumar Sahoo, Pleasanton, CA (US); Graeme Keith Rocher, Donostia (ES); Andriy Dmytruk, Toronto (CA)

(21) Appl. No.: 19/211,858

(22) Filed: May 19, 2025

(51) Int. Cl. G06F 9/54; H04L 69/22

(52) U.S. Cl. CPC G06F 9/541; H04L 69/22; G06F 2209/461

(57) ABSTRACT

Mechanisms are provided for modifying an abstraction layer of a modular application framework to support network communications with application code that does not have embedded network communication support in a serverless manner. A request adapter of the abstraction layer is executed which bridges network request data targeting a target application, and a network request abstraction of the abstraction layer of the modular application framework. A response adapter of the abstraction layer generates a response object based on a network communication library and enabling integration with a servlet-compatible layer of the modular application framework. A serverless application adapter of the abstraction layer provides a wrapper enabling the modular application framework to produce responses to requests in a format compatible with network data. A request is processed via the serverless application adapter and request adapter, and a response is processed via the serverless application adapter and response adapter.

### FIELD OF THE INVENTION

The illustrative embodiments are directed to an improved computing tool and improved computing tool operations/functionality for implementing an application programming model that has automated network channel mapping to standardized application input/output streams. Moreover, the illustrative embodiments provide an improved computing tool and improved computing tool operations/functionality for implementing a serverless modular application framework for serverless applications.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Traditional programs use standard streams of STDIN and STDOUT for input and output connections between a computer program and its environment. In particular, standard input (STDIN) is the input stream a program uses to receive data, typically from the keyboard or a file. Standard output (STDOUT) is the output stream where a program sends its results, usually to the screen or a file. An additional stream, referred to as standard error (STDERR) is where the program writes diagnostic output, e.g., error messages, to a screen or file. These standard streams are initiated when the program begins execution.

### BRIEF DESCRIPTION OF THE DRAWINGS

In the drawings:

FIG. 1 is an example block diagram of a virtualization architecture in which aspects of the illustrative embodiments may be implemented;

FIG. 2 is an example diagram illustrating an operation of the tinyinit engine in accordance with one illustrative embodiment;

FIG. 3 is an example diagram of example code for an application to implement the standard input and output streams for network connections in accordance with one illustrative embodiment;

FIG. 4 is a flowchart outlining an example operation for establishing a network connection to an application instance in accordance with one illustrative embodiment;

FIG. 5 is an example diagram illustrating a modified modular application framework that is modified to support serverless applications in accordance with one illustrative embodiment;

FIGS. 6A-6D are diagrams of an example portion of code for a request module in accordance with one illustrative embodiment;

FIGS. 7A-7B are diagrams of an example portion of code for a response module in accordance with one illustrative embodiment;

FIGS. 8A-8C are diagrams of an example portion of code for a serverless application module in accordance with one illustrative embodiment;

FIG. 9 is a block diagram that illustrates a computer system upon which an embodiment of the invention may be implemented; and

FIG. 10 is a block diagram of a basic software system that may be employed for controlling the operation of a computer system upon which aspects of the illustrative embodiments may be implemented.

### DETAILED DESCRIPTION

### GENERAL OVERVIEW

The illustrative embodiments provide a programming model and corresponding improved computing tools and improved computing tool operations/instructions to repurpose the standard input (STDIN), standard output (STDOUT), and standard error (STDERR) streams for network communication channel mapping so that applications may be developed without having to integrate into the application code support for networking, e.g., including servers, listeners, socket support, or the like. This greatly simplifies the requirements on application developers, allowing them to program computer applications without having to include in their programs specific network communication support and computing environment specific elements. To the contrary, with the mechanisms of the illustrative embodiments, using HyperText Transport Protocol (HTTP) or other network protocols, requests are written to the STDIN (File Descriptor (FD) 0) stream of an application and responses are written to the STDOUT (File Descriptor (FD) 1) stream of the application or program (these terms are used interchangeably herein to refer to computer executed code). The application may implement a parser to read requests from the STDIN stream and write responses to the STDOUT stream. The mechanisms utilizes a traditional operating system (OS) process model, i.e., traditional management and execution of programs or processes (including creation, scheduling, and termination) on the computer hardware.

The initialization of applications upon receiving a request for the application, and the mapping of network communication channels to the STDIN and STDOUT of the application, may be implemented via a relatively small sized initialization and mapping engine, referred to herein as the “tinyinit” engine. In some illustrative embodiments, the tinyinit engine also works in conjunction with a virtual hypervisor (or “Visor”) of a virtualized operating system, to which system calls are routed within an isolated virtual machine environment, rather than providing direct access to the operating system. The tinyinit engine listens for requests for an application and launches a corresponding application instance when a request is received. There may be a separate application instance for each communication connection and a corresponding tinyinit engine instance for each application instance. The tinyinit engine maps network connections to the standard input (STDIN) and output (STDOUT) streams of the launched application instance using file descriptors FD0, FD1. Thereafter, when communications occur over the network connection with regard to the specific application instance, the communications are written to/read from the corresponding standard streams via the mapping implemented by the tinyinit engine instance. When the network connection closes, e.g., the TCP connection closes, the launched application stops executing and resources allocated for the application process can be reclaimed by the operating system.

The illustrative embodiments allow applications that are not necessarily programmed for implementation in a networked environment to be able to operate in such an environment and communicate over network connections using network protocols. That is, the application programmer does not need to facilitate, in the programming of the application itself, the creation of threads, sockets, or the like, which would otherwise be required for a networked application. For example, a program that is designed for implementation at a local computing device, and which implements the STDIN and STDOUT streams, can communicate over HTTP connections by having HTTP requests written to STDIN and HTTP responses by the application written to STDOUT, with the parser of the programming reading from STDIN and the program writing to STDOUT. After tinyinit spawns the process and sets up the socket to process STDIN and STDOUT, the operating system ensures that whatever the application process writes to its STDOUT, it is sent to the client. Similarly, whatever the client writes to the socket, the application process can read using STDIN. The STDERR (File Descriptor (FD) 2) stream may still be used for logging error messages and reporting diagnostic information, even for such HTTP requests/responses.

The mechanisms of the illustrative embodiments avoid forking unnecessary processes by implementing a read, evaluate, print (REPL) loop. That is, it is common for a client to make multiple requests on the same connection and this is achieved with the mechanisms of the illustrative embodiments using the REPL loop. Each process lifecycle matches that of a connection and when a client sends subsequent requests, the existing process is able to handle it. Moreover, a per request garbage collection policy is made possible by invoking garbage collection at the end of each iteration.

By decoupling the program from the implementation of the channel, it can be plugged in more places, e.g., the requests could be read from a keyboard, file, or socket and a response can be sent to a display, file, or socket. The socket can be either an Internet socket or UNIX domain socket.

With the mechanisms of the illustrative embodiments, the application retains the look and feel of a traditional application, with the programmer continuing to have direct control over the main method, choice of libraries, etc., while still being able to operate over network connections using network protocols. The application programming involves only the business logic itself, with other runtime features, such as concurrency, scaling, secure socket layer (SSL), networking, authN, etc., being handled by the network servers, e.g., web servers, instead of being reimplemented in the programming runtime. Thus, the application is truly serverless in that there is no use of any socket application programming interface (API) or embedded servers in the program. The application is also not required to be multi-threaded in order to provide networked solutions. That is, other solutions require programs to be multi-threaded due to the use of server/listen sockets inside of them, whereas the illustrative embodiments do not require such multithreading or server/listen sockets.

Moreover, since the illustrative embodiments do not require such multithreaded programming, the programs generated using the programming model of the illustrative embodiments eliminates the multithreading complexity and simplifies analysis and tuning of the program. That is, while other approaches try to hide the complexity of sockets and threads, they inevitably expose programmers to complicated configuration parameters related to threads and sockets.

### EXAMPLE VIRTUALIZATION ARCHITECTURE EMBODIMENTS

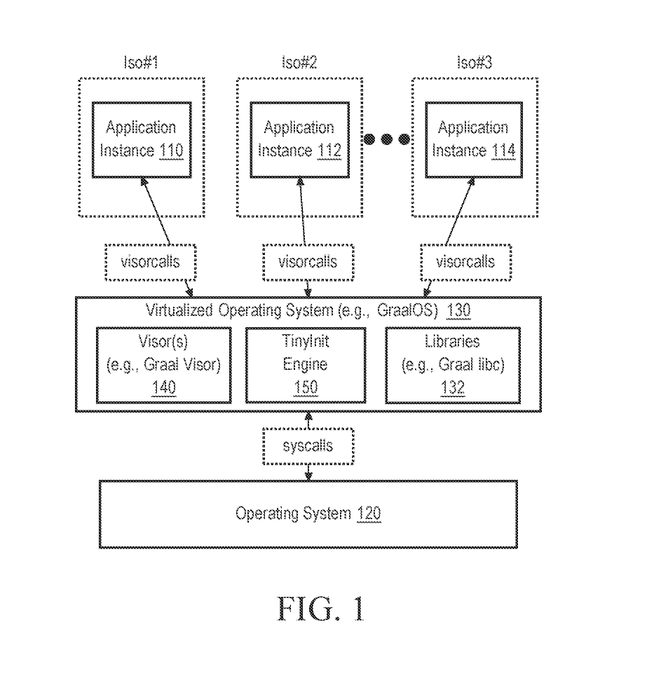

FIG. 1 is an example diagram of a virtualization architecture in which aspects of the illustrative embodiments may be implemented. The virtualization architecture of FIG. 1 provides a serverless cloud computing environment in which applications are able to share an underlying operating system, yet are isolated from one another, via a virtualized operating system and corresponding mechanisms for enforcing this isolation between application instances and their runtimes. It should be appreciated that, while the mechanisms of the illustrative embodiments will be described in the context of the virtualization architecture shown in FIG. 1, this is only an example. In other implementations, the mechanisms of the illustrative may be implemented in non-virtualization based architectures, in which a lazy activation protocol engine and mapping of network communication channels to standardized input/output streams of applications may be provided in accordance with one or more illustrative embodiments of the present invention.

Cloud computing has fundamentally reshaped the landscape of modern information technology (IT) infrastructure and application deployment. Among the various paradigms that have emerged, serverless computing stands out as a revolutionary model that challenges traditional approaches to resource management and scalability. Serverless computing, often referred to as Function-as-a-Service (FaaS), has gained significant traction due to its potential to reduce operational overhead, improve cost efficiency, and accelerate development cycles. By enabling event-driven execution of small, stateless functions, serverless architectures offer an elastic and highly scalable solution that adapts to demand in real-time. This model is particularly attractive for modern applications that experience fluctuating workloads, as it offers a pay-as-you-go pricing model where users only pay for the actual compute resources consumed during execution.

Serverless computing platforms are typically offered by major cloud service providers, each providing a unique set of runtimes that allow developers to run code without worrying about the underlying infrastructure. These runtimes are crucial because they determine the languages and environments in which serverless applications can execute, and they directly impact the performance, scalability, and usability of serverless solutions.

In FIG. 1, a serverless computing platform is provided that implements a virtualization architecture in which, in addition to providing isolated runtimes via virtual machine mechanisms, the operating system itself is virtualized via the incorporation of an additional layer 130 of virtualization between the application instances 110-114 and the underlying operating system 120. This virtual operating system 110 provides mechanisms that run in the same isolated environment as the application instances 110-114 which ensure security boundaries between the application instances while they share the same underlying operating system 120 resources.

One example implementation of an operating system virtualization, which addresses the challenges of traditional serverless runtimes, is GraalOS available from Oracle International Corporation. GraalOS uses GraalVM Native Image to run applications as native machine executables. In the context of serverless computing, GraalOS promises fast startup times, low latency, reduced memory consumption for applications, and other improvements in the context of serverless computing, with high performance even when applications are scheduled on the same process. Examples of the illustrative embodiments will be described herein with regard to GraalOS as the virtualized operating system 130, however the illustrative embodiments are not limited to such and any other virtualized operating system 130 that provides isolation of application instances 110-114 through an additional layer of virtualization between the application instances 110-114 and the underlying operating system 120 may be used without departing from the spirit and scope of the present invention.

In a GraalOS 130 implementation, each application 110-114 is run as a thread, in a process called a Graal Visor 140-144 which is a type of hypervisor that acts as a mediator between the operating system (OS) kernel in OS 120, e.g., Linux kernel, and the Graal libraries 132 of the GraalOS 130. In some illustrative embodiments, there is a 1-to-1 relationship between application instances 110-114 (or Isolates) and visors 140-144. The Graal libraries 132 may include a Graal libc library which is a customized version of the standard library libc implementation provided by GraalOS 130 which exposes the standard libc interface, but routes system calls from the application instances 110-114 to the corresponding Graal Visor 140-144 rather than the underlying operating system kernel in OS 120. This prevents the underling operating system kernel 120 from being directly accessed from the application code of the applications 110-114. In some illustrative embodiments, multiple applications, i.e. threads, can be run concurrently on one Graal Visor 140. This means that changing between different application instances 110-114 becomes faster since it equates to changing the running thread. This also means that inter application communication can be done in-memory.

GraalVM is an advanced JDK with ahead-of-time Native Image compilation. GraalVM accelerates application performance while consuming fewer resources. It achieves this by compiling Java applications ahead of time into a native binary or native image. The native image is an output of the GraalVM native image tool that produces an architecture specific executable for GraalOS 130, such as from Java classes. The executable is also linked with the Graal libraries 132. The native binary is smaller, starts up to 100x faster, provides peak performance with no warmup, and uses less memory and Central Processing Unit (CPU) than an application running on a Java Virtual Machine (JVM). Thus, the integration of GraalVM with GraalOS improves the startup time and resource usage of applications.

When a Graal Visor, e.g., Graal Visor 140 loads a native image, it creates an isolated runtime execution environment referred to as a Graal “Isolate” or “Iso”. Where a native image may be considered the program, a Graal Isolate, or simply Isolate, can be considered to be a process. For example, three application instances may be loaded by their corresponding Graal Visors 140-144 and thus, three isolated runtime execution environments are created (represented by the dotted lines between application instances 110-114), such that the application instances 110-114 represent Isolates, or Iso’s, #1-#3. These Isolates communicate system calls to the operating system 120 which are routed to the Visor 140-144 of the GraalOS 130 and thus, are referred to as “visorcalls.” Thus, rather than the system calls going to the OS 120, the virtualized operating system of the GraalOS 130 intercepts these system calls so that the virtualized operating system 130 is able to maintain isolation between the Isolates while sharing the underlying OS 120 resources.

### MCIRONAUT FRAMEWORK

The example virtualization architecture of FIG. 1 may utilize a modular application and/or microservices framework, an example of which is the Micronaut framework. The illustrative embodiments are fully compatible with the Micronaut framework but may be implemented in other modular application frameworks as well. Thus, while Micronaut is provided herein as an example, the illustrative embodiments are not limited to such and other modular application/microservices frameworks can be similarly used to implement aspects of the illustrative embodiments without departing from the spirit and scope of the present invention.

Assuming a Micronaut framework as an example, Micronaut is a full-stack framework designed for building microservices, serverless applications, and applications in resource-constrained environments. It is an alternative to traditional Java frameworks, offering distinct advantages, particularly when it comes to modern cloud-native applications.

Micronaut provides compile-time dependency injection (DI). Unlike traditional frameworks which rely heavily on runtime reflection for dependency injection, Micronaut leverages compile-time dependency injection. This approach eliminates the need for reflection, resulting in a significant reduction in runtime overhead. By resolving dependencies at compile time, Micronaut ensures that applications are lightweight, faster, and more efficient. This is especially important in microservice architectures, where resources and performance are critical.

Micronaut provides a small memory footprint and low latency. Micronaut is designed to minimize the memory consumption of applications and provide high performance. This is achieved by optimizing the framework’s internals and minimizing unnecessary resource usage. Micronaut’s architecture ensures that it works well in environments with limited resources, such as cloud environments or serverless platforms. Its low memory footprint and fast startup times make it a strong contender for serverless applications, where cold start times are a critical factor.

Micronaut supports GraalVM and native image compilation. That is, a compelling feature of Micronaut is its compatibility with GraalVM, which allows developers to compile Micronaut applications into native executables using GraalVM’s native-image tool. This enables significant reductions in startup time and memory usage. This makes Micronaut applications even more suitable for cloud and serverless environments. The integration with GraalVM allows Micronaut applications to run with near-instant startup times, making them ideal for highly dynamic environments like serverless platforms.

Micronaut provides built-in caching support for applications, making it easy to cache data at the method or class level. This allows developers to easily store and retrieve frequently accessed data, thereby improving the performance of their applications by reducing the need for repeated data retrieval or computation. Caching can be used to store results of method calls, database queries, or API responses. Micronaut’s caching mechanism is highly configurable and can be customized based on application needs. Micronaut allows users to provide their own custom cache implementations, enabling greater flexibility for developers. If the default caching solutions do not meet the specific needs of an application, users can integrate custom caching mechanisms by implementing the cache interface. This custom cache implementation can then be used in the same way as any built-in cache, providing developers with full control over cache behavior, eviction policies, and storage mechanisms. This feature allows applications to utilize tailored caching solutions optimized for their unique requirements.

### GRAALVM

As mentioned above, GraalVM is an advanced Java Development Kit (JDK) with ahead-of-time native image compilation, designed to run applications written in multiple programming languages. GraalVM supports a wide variety of languages, including Java, JavaScript, Ruby, R, Python, and WebAssembly. This polyglot nature makes GraalVM a powerful tool for developers working in multi-language environments, as it allows for interoperability between languages and seamless execution within the same runtime.

GraalVM features a just-in-time (JIT) compiler called Graal, which is designed to produce highly optimized machine code, resulting in improved execution performance. GraalVM enhances the speed and efficiency of applications, particularly those that require heavy computational workloads. GraalVM introduces the native-image functionality, which enables developers to compile Java applications (and applications in other programming languages) into native executables. These native executables start up faster and consume less memory compared to traditional JVM-based applications, making them an ideal choice for cloud-native and serverless applications.

GraalVM allows for seamless interaction between different programming languages within the same runtime environment. For example, a Java application can directly invoke C code without the need for external bridges or complex integrations. This polyglot feature makes it easier for developers to combine tools and libraries from various programming ecosystems while benefiting from the optimizations of a single runtime.

GraalVM provides enhanced profiling and debugging capabilities that allow developers to optimize their applications more effectively. With support for advanced profiling tools and a more detailed view of the program’s execution, developers can identify performance bottlenecks and optimize their applications accordingly. In addition, GraalVM also allows native images to include C/C++ libraries. These libraries can be used in the Java application as if they were Java functions.

### GRAALOS

As mentioned above, GraalOS is a high-performance serverless application deployment platform. GraalOS fully integrates GraalVM’s polyglot capabilities, allowing developers to write, execute, and interoperate code in multiple programming languages, such as Java, JavaScript, Python, Ruby, R, and C/C++. This feature promotes language-agnostic development, enabling teams to use the best-suited language for each component of their applications. As discussed above, FIG. 1 is an example block diagram illustrating an example GraalOS configuration in accordance with one illustrative embodiment.

As shown in FIG. 1, GraalOS runs different applications or application instances 110-114, i.e. untrusted native code, as “Isolates”, e.g., Iso#1, Iso#2, and Iso#3. These Isolates are independent from each other, which means that from their point of view, they have access to all the resources the operating system (OS) 120 provides. Isolates (Iso#1, Iso#2, and Iso#3), corresponding to application instances 110-114, access these resources using syscalls, as in a regular operating system. GraalOS 120 introduces an in-process security boundary that separates the privileged (and trusted) Graal Visor 140-144, or simply the “Visor”, from the unprivileged (and untrusted) “Isolate”. This is similar to the boundary that would be established between a regular operating system kernel and a process. From the point of view of Isolates (Iso#1, Iso#2, and Iso#3), they are running as processes on top of an OS kernel of the OS 120. All Isolate code is untrusted. There are no restrictions in place that prevent Isolate code from modifying or corrupting its own state, but it may not compromise the confidentiality, integrity and availability of the Visor 140-144. The Visor 140-144 executes in user-mode within the same operating system process as the Isolate it manages. Isolation between the Isolate and the Visor 140-144, as well as the other Isolates, is achieved using both software and hardware mechanisms.

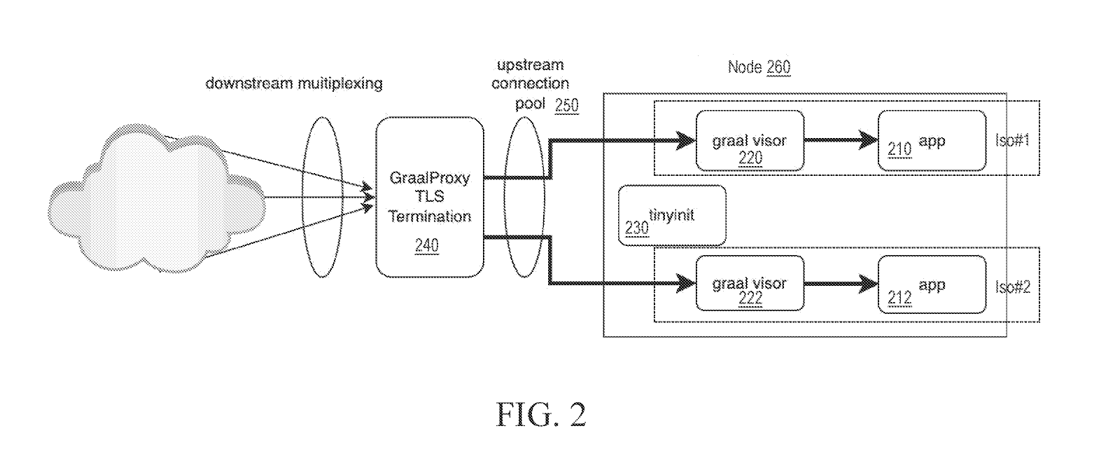

In contrast to running the Isolate (Iso#1, Iso#2, and Iso#3) corresponding to the application instances 110-114 as a regular process on the host OS 120, running an Isolate on GraalOS 130 provides stronger protection through the additional security boundary introduced by GraalOS 130. An Isolate (Iso#1, Iso#2, and Iso#3) cannot directly invoke system calls, and instead invocations are managed by the Visor 140-144. There may be a separate Visor instance 140-144 for each application (see FIG. 2 as an example), but application instances 110-114 of the same application may share the same Visor, e.g., Visor 140. Further, an Isolate’s instruction stream is significantly limited, i.e., compared to a regular user-mode process, an Isolate (Iso#1, Iso#2, and Iso#3) has to conform to specific patterns for control flow transfers and cannot contain numerous potentially security-critical instructions. The user-supplied Isolate binary executable code of the user application is first verified by binsweep, which is a code scanning tool that examines code and checks whether it conforms to GraalOS’s policies, i.e., whether the code contains illegal instructions, control flows, or dependencies. Isolates are built with a custom toolchain including modified compilers that only emit GraalOS policy conforming code.

Upon successful examination, the Visor 140 loads the application code into an isolated region of the Visor’s address space. The result of loading an application instance 110-114 is an active instance of a corresponding Isolate (Iso#1, Iso#2, and Iso#3). The Visor 140 can now execute the Isolate’s entry point. The Visor 140 supports executing multiple instances of the same application 110-114 and thus, multiple Isolates (Iso#1, Iso#2, and Iso#3). To perform privileged operations, the Isolate corresponding to an application instance 110-114 invokes the Visor’s 140 system call virtualization. This means that whenever an Isolate corresponding to an application instance 110-114 does an allowed syscall, the syscall is intercepted by the Visor 140 and is referred to as a “visorcall”. A visorcall uses the custom GraalOS library 132, e.g. the custom libc implementation, rather than accessing the underlying operating system 120 directly. The GraalOS 130 is responsible for the corresponding syscalls to the underlying operating system 120, thereby implementing a virtualized OS that sits on top of the actual underlying operating system 120. This facilitates multiple Isolates corresponding to application instances 110-114 sharing the same underlying operating system 120 while maintaining security boundaries between the Isolates (Iso#1, Iso#2, and Iso#3) and thus, their corresponding application instances 110-114.

In accordance with some illustrative embodiments, each Isolate (Iso#1, Iso#2, and Iso#3) has a corresponding Graal Visor instance that is generated as a result of the operation of the tinyinit engine 150. There may be a separate tinyinit engine 150 instance for each application, and each tinyinit engine 150 may support multiple application instances of its corresponding application. The tinyinit engine 150 and Graal Visor instances 140-144 are used to initialize the corresponding application instances 110-114 as the Isolates 110-114 when a request for the application instance comes in on a channel or upstream connection. The tinyinit engine 150 and Graal Visors 140-144 map network connections to the standard input and standard output streams of the application instance 110-114.

The tinyinit engine 150, in response to receiving a first request targeting an application via an upstream connection of an upstream connection pool, forks an instance of the Graal Visor 140-144 which in turn loads the application instance 110-114 into an isolated memory space of the Graal Visor 140-144 which creates a process for implementing a corresponding Isolate. The tinyinit engine 150 passes along to the Graal Visor 140-144 the connection information for mapping network connections to the standard input and output streams of the application instance. The application instance uses these standard input and output streams to perform network communications without having to implement within the application code itself support for networking, such as servers, sockets, and the like.

### ROUTING OF REQUESTS TO APPLICATION INSTANCES

In accordance with one or more illustrative embodiments, routing of requests and responses uses a multi-tiered routing protocol. With regard to the routing of requests to an application instance (e.g., an Iso#1) in a first tier, Domain Name Service (DNS) based routing may be utilized. The DNS routing directs traffic to an appropriate IP address based on a domain name query. This tier of routing uses well known mechanisms for routing to an IP address using DNS and thus, further details are not provided herein.

In a second tier, a network load balancer, such as the Oracle Cloud Infrastructure (OCI) Network Load Balancer available from Oracle International Corporation, or the like, may be used to route requests to a specific node, where a node is a multi-tenanted virtual machine instance used to host Graal Visor instances 140-144 in this example. In some illustrative embodiments, the Network Load Balancer (NLB) is a non-terminating connection aware load balancer, i.e., the NLB forwards packets for the same connection to the same backend even though it is operating at OSI layer 3. Each server cluster has a dedicated NLB to make clusters independent of one another. Each NLB is configured with a listener, e.g., Transmission Control Protocol (TCP) listener, that listens on a particular port, e.g., port 443. The NLB is also configured with a backendSet containing all the nodes of the corresponding cluster. OCI Instance Pool and Autoscaling (IPA) Service may be used to keep the backendSet up-to-date. NLB health checks allow the failing of requests fast when a node fails. Client retries automatically get routed to healthy nodes by the NLB.

Once the request arrives at the node, a proxy, e.g., a layer and reverse proxy referred to as Graal Proxy in the illustrative embodiments, is utilized as part of a third tier of routing. The Graal Proxy maps each application to a server or virtual host inside a web server, e.g., nginx. The web server terminates the TCP and Transport Layer Security (TLS) Session. The web server uses the Server Name Indication, which is part of the Secure Socket Layer (SSL) handshake, to select an appropriate server.

In a fourth tier, path-based routing to a particular application instance is performed based on the path information inside the HTTP request. Each application gets a unique path under the application’s domain, where the domain is a logical container for executing the application and provides isolation, security, and management of resources for the application instances running within it. An application instance is a runtime instance of the application and is what handles requests. Each application gets a unique URL (which is a unique combination of host and path). When requests for an application specific URL arrives, the system maps it to an application and determines if there is an existing application instance that can handle the request, a new application instance needs to be created, or a limit is reached in which case it can apply an appropriate policy. Each path is mapped to an upstream block inside the web server, e.g., nginx. Although an upstream block represents a load balanced group of origin servers, it is configured with a single origin server listening at a domain socket, e.g., Unix domain socket. The web server is a terminating proxy and thus, it uses new TCP connections to communicate with origin servers.

Of particular note to the mechanisms of the illustrative embodiments, in a fifth tier of routing, a lazy activation protocol is implemented via the tinyinit engine 150. The tinyinit engine 150 implements a lazy activation protocol in which a child process is initiated upon first connection attempt, and a file descriptor corresponding to the listening socket is provided to the forked process. The tinyinit engine 150, is configured to activate a virtual hypervisor, such as the Graal Visors 140-144, when it receives the initial request for an application over a network communication channel. The virtual hypervisor is configured with application specific configurations, such that when the proxy opens a connection to an application, the tinyinit engine 150 will fork a new virtual hypervisor process which loads the application specific image in an isolated memory region to generate a resulting isolated execution environment, or Isolate 110-114.

### TINYINIT ENGINE

FIG. 2 is an example diagram illustrating an operation of the tinyinit engine, such as tinyinit engine 150 in FIG. 1, in accordance with one illustrative embodiment. In the example shown in FIG. 2, two application instances 210-212 of the same application have been initiated and have corresponding Graal Visor instances 220-222. That is, as mentioned above, when initial requests for the application come in, the tinyinit engine 230 forks the processes for the Isolates and provides a file descriptor corresponding to the listening socket to the forked process. The forked process accepts all connections and handles them internally.

With the illustrative embodiments, there is a dedicated tinyinit engine 150 per application, which may support multiple application instances 110-114 and Isolates (e.g., Iso#1 and Iso#2). The tinyinit engine, e.g., tinyinit engine 150, is configured with the Graal Visor as the program to be activated. Each Graal Visor instance 140-144 (again, there may be a separate Graal Visor 220, 222 for each Isolate) is configured with application specific configurations, such as executable location, environment variable, resource limits, etc. Thus, when the Graal Proxy 240 opens a connection, the tinyinit engine 150 will fork a new Graal Visor 140-144 process. The Graal Visor, e.g., Graal Visor 140, then loads the application specific image in an isolated memory region to generate a resulting isolated execution environment, or Isolate. In FIG. 2, two Isolates Iso#1 and Iso#2 are shown which comprise the corresponding application instances 110, 112, Graal Visor instances 220 and 222, and other elements for executing the application instances 210, 212 in an isolated runtime environment. The connection accepted by the tinyinit engine 150 is passed as file descriptors to the corresponding Graal Visor 220, 222, which then passes the exact same file descriptors to the application instance 210 or 212 of its Isolate Iso#1, Iso#2.

Once the Graal Visor 220, 222 has activated its application as an Isolate, each Isolate has access to three well-defined streams, i.e., FD 0 (System.in/STDIN/std::cin) which is used to read requests, FD 1 (System.out/STDOUT/std::cout) which is used to write responses, and FD 2 (System.err/STDERR/std::cerr) which is used for logging/debugging. Again, as noted above, the standardized input stream (STDIN) is traditionally used for receiving inputs from a peripheral device, such as a keyboard, or from a file, and the standardized output stream (STDOUT) is traditionally used for outputs to a computer screen or file. These standardized input/output streams are not used for network communications in traditional programming. However, the illustrative embodiments provide mechanisms to allow these standardized streams to be repurposed for network communication.

The application code can use any parser, e.g., an HTTP parser, suitable for the particular implementation to read requests from the STDIN (FD 0) stream and write responses to the STDOUT (FD 1) stream. The application code may be generated through any suitable framework, such as the Micronaut framework as described previously, or the like. The application framework handles HTTP parsing inside the application code. The application instance 210, 212 keeps reading the input stream (STDIN) as long as the input stream is open. Maintaining this level of contact allows the programming model of the illustrative embodiments to operate with various programming languages, such as Python and JavaScript, for example.

Graal Proxy 240 is ultimately responsible for activation of application instances 210, 212. The number of upstream connections in the upstream connection pool 250 is equal to number of Isolates Iso#1, Iso#2. By limiting the number of upstream connections in the upstream connection pool 250, the number of Isolates for an application per node 260 may be controlled. Requests that cannot be assigned to Isolates may be queued by the Graal Proxy 240 if a queue structure is implemented, otherwise the request may be immediately rejected if such a queue structure is not used in the implementation. In the case that a queue structure is used, the Graal Proxy 240 may implement throttling to limit queue depth.

An application can be called multiple times in quick succession and then become idle for quite some time. In order to avoid rapid start/stop, the Graal Proxy 240 maintains a persistent connection (e.g., HTTP/1.1 keep-alive feature) with the application instance 210, 212 and reuses the same connection for sending subsequent requests to the application instance 210, 212. In order to support single threaded programs, in one or more illustrative embodiments, the Graal Proxy 240 may not use the HTTP pipeline feature and instead sends a new request using the same connection after the earlier request has been responded to.

Furthermore, an idle timeout may be configured on the upstream connections of the upstream connection pool 250, where the idle timeout may be monitored by an idle timeout timer that measures an amount of time between requests received over the upstream connection, a number of requests received in a period of time, or the like. Conditions may be specified for the idle timeout timer to indicate when the connection should be closed. For example, when there are not enough requests for an application instance 210, 212, over the upstream connection, the upstream connection may be closed due to the idle timeout setting. When the connection is closed, the streams, i.e., STDIN and STDOUT, are closed inside the Isolate Iso#1, Iso#2, forcing the application instance 210, 212 to exit. This exit behavior can be implemented in a framework, such as Micronaut or the like. When the Isolate exits, the Graal Visor 220, 222 process also exits.

### EXAMPLE CODE FOR AN APPLICATION TO USE STANDARD INPUT/OUTPUT STREAMS FOR NETWORK CONNECTIONS

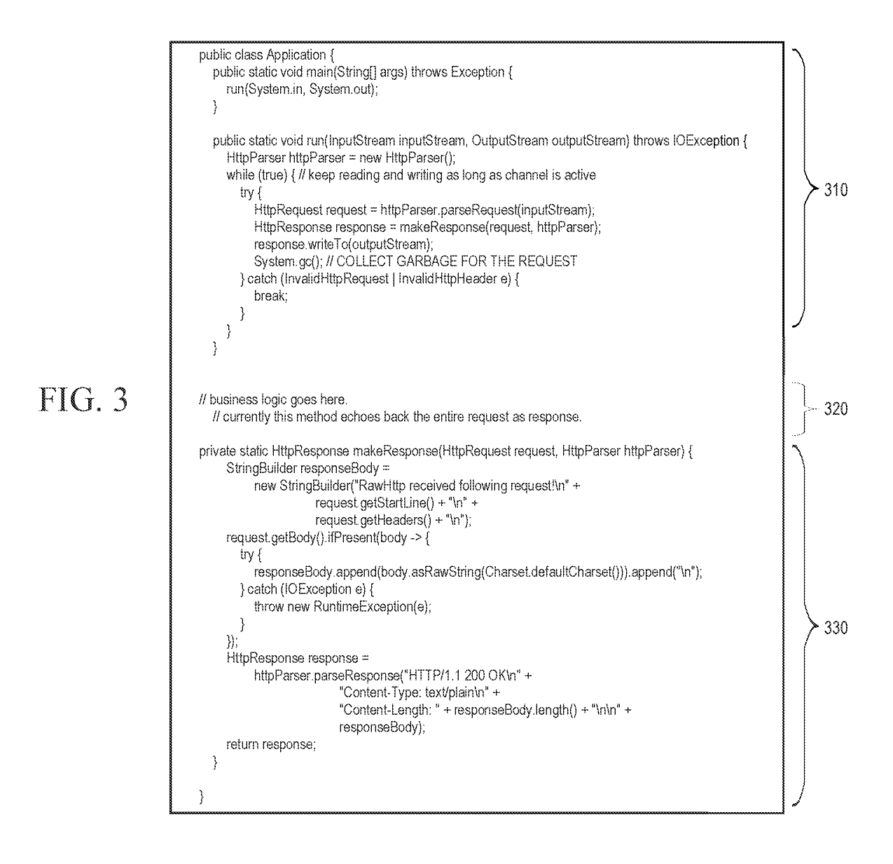

FIG. 3 is an example diagram of example code for an application to implement the standard input and output streams for network connections in accordance with one illustrative embodiment. As can be seen in FIG. 3, a first portion 310 of the code establishes the input and output streams (STDIN/STDOUT) and the logging/dynastic stream (STDERR) for use with HTTP communication connections. As can be seen from this code in the first portion 310, the requests are received via the “inputStream” and responses are written out to “outputStream”. The while loop causes the code to continually read and write to the standard input and output streams as long as the upstream channel is activity. A second portion 320 comprises the business logic. The third portion 330 generates responses or throws exceptions based on the business logic operations of the second portion 320. Notably, there is no need for any sockets, servers, or other networking support within the code itself.

### EXAMPLE CREATION OF NETWORK CONNECTIONS WITH STANDARD INPUT/OUTPUT STREAMS

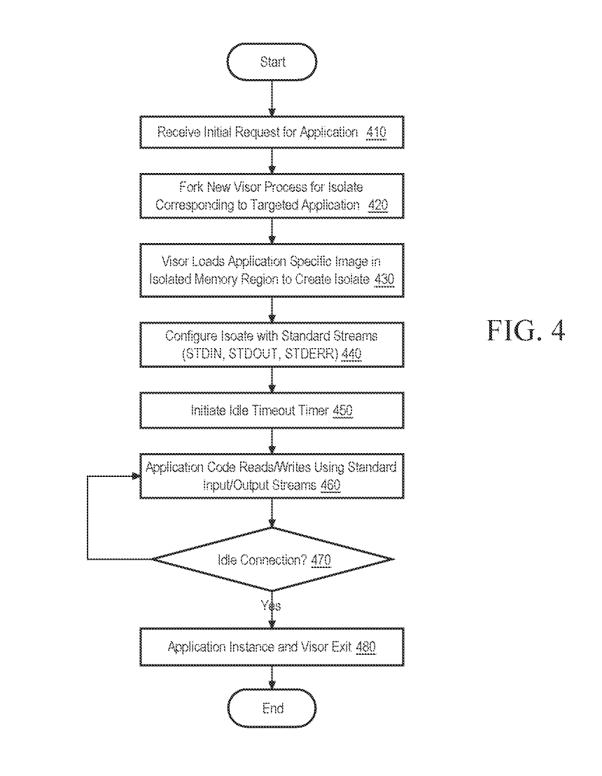

FIG. 4 is a flowchart outlining an example operation for establishing a network connection to an application instance in accordance with one illustrative embodiment. As shown in FIG. 4, the operation starts with receiving an initial request for an application coming in from an upstream connection of an upstream connection pool for network traffic (step 410). As discussed earlier, this request may be routed through multiple levels, e.g., tiers 1-4, of a multi-layered or multi-tiered routing architecture. A proxy, such as a Graal Proxy, may receive traffic and allocate connections from an upstream connection pool to the targeted application. The request is sent along a proxy allocated or opened connection to the tinyinit engine, triggers the tinyinit engine forking a new Visor process for an Isolate corresponding to the targeted application (step 420). The Visor then loads the application specific image in an isolated memory region to generate a resulting isolated execution environment, or Isolate (step 430). The connection accepted by the tinyinit engine is passed as file descriptors to the corresponding Visor 250 which then passes the same file descriptors to the application instance of the Isolate (step 440).

Once the Visor has activated its application instance as an Isolate (step 430) the Isolate is configured with the standard well-defined streams, i.e., FD 0 (System.in/STDIN/std::cin), FD 1 (System.out/STDOUT/std::cout), and FD 2 (System.err/STDERR/std::cerr) (step 440). An idle timeout timer is initiated for the connection, which is reused for the application instance, with the timer resetting with each request/response submitted via the standard input/output streams and the allocated connection from the upstream connection pool (step 450). The code of the application instance keeps reading the input stream (STDIN) as long as the input stream is open, and writing responses to the output stream (STDOUT) (step 460). Thus, as additional requests are received, the looping nature of the application instance reading the input stream and writing to the output stream allows for reuse of the connection using the standard input/output streams of the application.

A determination is made as to whether the connection has become idle, such as based on the idle timeout timer or based on the connection having been closed through other mechanisms (step 470). If so, then the application instance and Visor are exited and the operation terminates (step 480). If not, then the operation returns to step 460 with the code continuing to read/write to the STDIN and STDOUT streams, which are mapped to the upstream connection and thus, the network.

### ADVANTAGES OF THE PROGRAMMING MODEL AND IMPROVED COMPUTNG TOOLS

The following are some, but not all, of the advantages offered by the programming model and mechanisms of the illustrative embodiments. As previously mentioned, the illustrative embodiments simplify application development to focusing on business logic without requiring the implementation of servers or sockets in the application code itself. This eliminates the need for multithreading and socket complexities in the code, allowing ease of analysis of the application execution. Moreover, the illustrative embodiments, provide improved computing tools and improved computing tool operations/functionality that are programming language agnostic such that applications written in C, Java, or any other programming language may be executed using standard streams and have their standard streams used to perform network communications.

The illustrative embodiments are operating system agnostic. Although the examples of the illustrative embodiments described above provide a programming model for a virtual operating system, such as GraalOS, the mechanisms of the illustrative embodiments and the programming model also may be implemented with an actual, i.e., non-virtual, operating system such as Linux, MacOS X, or Windows, for example.

The illustrative embodiments present a solution that has a minimal footprint due to the absence of any server frameworks, networking logic, threads, etc. For example, a statically linked native-image for the above example Java application implementation may be only 10MB in size. This includes necessary components of a Java Virtual Machine and language runtime for a fully functional application.

The illustrative embodiments provide a solution that supports ultra-fast cold start latency. It has been found that cold start request latency is only 10ms on a developer computing device, which includes spawning a new process to serve a request.

The illustrative embodiments provide a programming model in which program code retains the look and feel of a traditional application code. That is, the programmer continues to have direct control over the main method, choice of libraries, and the like. Moreover, the program code is truly server-less, as there is no use of any socket API or requirement to embed HTTP servers in the program code.

While other solutions require programs to be multi-threaded due to the use of a server/listen socket inside the program code, the mechanisms of the illustrative embodiments do not require multiple threads. Multi-threaded programs are difficult to analyze and tune, whereas the illustrative embodiments eliminate such complexity with parallelization being handled at a higher level component, such as a web server.

The applications or programs developed using the programming model of the illustrative embodiments may be plugged into any existing server framework, such as nginx, Unix superserver, Apache Tomcat, or the like. The programming model of the illustrative embodiments does not force any web development framework, such as Micronaut, Spring, Jakarta EE, Node.js, etc. To the contrary, the programming model of the illustrative embodiments has been proven compatible with various frameworks.

With the applications or programs generated using the programming model of the illustrative embodiments, while an instance of the application or program only handles one request concurrently, the same instance can be used to handle several requests in a pipeline fashion to reduce overhead of spawning processes for each request when requests arrive in a quick succession.

In some illustrative embodiments, the programming model supports a per request garbage collection (GC) functionality. With the mechanisms of the illustrative embodiments, in a garbage collected environment, such as JVM or the like, programmers can force collection of garbage by calling a garbage collector at the end of each request. This is possible because programmers are in direct control of request/response cycle. This type of garbage collection avoids the side effect of one request’s garbage affecting execution time of a subsequent request. In fact since applications or programs developed with the programming model of the illustrative embodiments have a very low cold start overhead, it is possible to avoid garbage collection overhead in a garbage collected environment by using epsilon GC and terminate the process entirely after each request.

With the illustrative embodiments, applications or programs natively support console (terminal) mode. This console mode significantly simplifies testing of the application or program.

### SUPPORT FOR SERVERLESS APPLICATIONS IN MODULAR OR MICROSERVICES APPLICATION FRAMEWORK

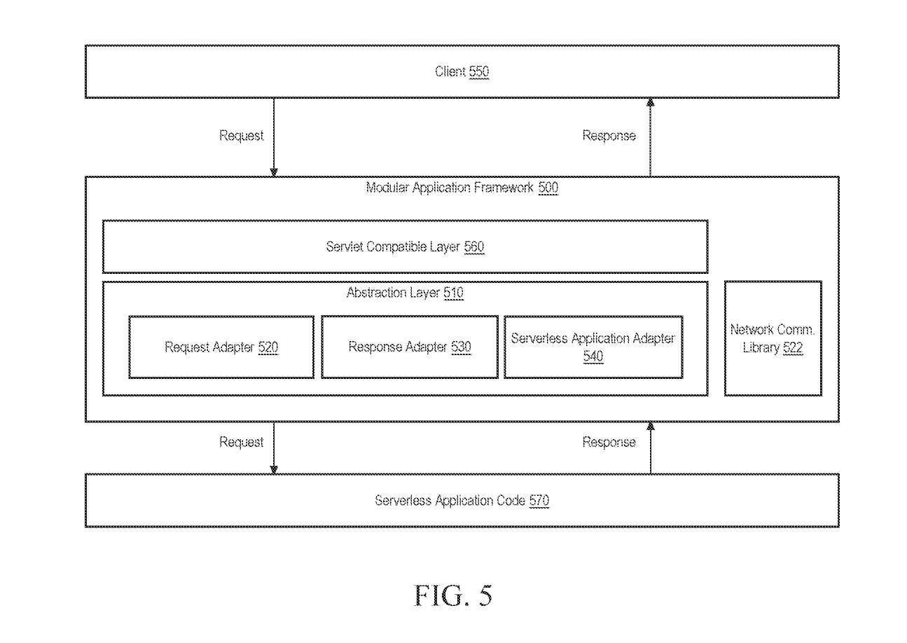

As noted above, in some illustrative embodiments, an improved computing tool and improved computing tool operations/functionality are provided for supporting, in a modular application framework, a serverless application implementation according to the above programming model, which uses the standardized input, standardized output, and standardized error streams for network traffic. An example of this modular application framework is the Micronaut framework as mentioned above. FIG. 5 is an example block diagram of a modular application framework implementation with support for the serverless application programming model in accordance with one illustrative embodiment. The example of FIG. 5 assumes a Micronaut framework for purposes of illustration and a HyperText Transport Protcol (HTTP) data communication, but is not limited to such and other modular application frameworks, microservices frameworks, and data communication protocols may be used without departing from the spirit and scope of the present invention.

Prior to the implementation of the modular application framework, and specifically Micronaut, applications would need to support the implementation of a server and socket APIs in the application code itself. This means that the application code would need to be programmed for a specific type of web server implementation, e.g., Netty, Jetty, Tomcat, or the like. The server would be embedded in the application code, as would the required APIs, e.g., socket APIs, for performing network communications. This means that if one wanted to implement the application with a different server, the application would need to be reprogrammed to support the new server type, or multiple different versions of the application would need to be provided, one version for each supported server type.

In order to address this inflexibility, the complexity of implementing such servers and communication APIs in the application or program code itself, and having to have programmers have detailed knowledge of networking in order to make their applications work in a networked environment, a modular application framework is provided, such as Micronaut, which has an abstraction layer that abstracts the networking from the application code. The abstraction layer handles all the networking functionalities for the applications, such as parsing requests (e.g., their verbs, request header, and request body) and responses (e.g., their response code, response header, and response body), such as, for a request, determining the Java class to direct the network packet to based on the request header, the method to invoke based on the verb, and the arguments to pass based on the body, etc. While the abstraction layer of the modular application framework provides the networking functionalities for the applications such that they are no longer required to provide support for servers and socket communications, the abstraction layer still expects a web server to be present and expects communication with such a web server. Thus, the application code implementation is not a truly serverless mechanism in that a web server is still part of the configuration, even though that web server may be any suitable web server due to the abstraction layer and is not fixed in the code of the application.

In accordance with one or more illustrative embodiments, mechanisms are provided to modify the abstraction layer of the modular application framework, e.g., Micronaut, to support truly serverless applications. In particular, as shown in FIG. 5, these illustrative embodiments modify the abstraction layer 510 of the modular application framework 500 to include a request adapter 520, a response adapter 530, and a serverless application adapter 540. The request adapter 520 acts as a bridge between network request data, e.g., HTTP request data from a client 550 (which may be a computing device, process, service, or the like), targeting an application code 570 and the abstraction layer’s 510 high-level network request abstraction, e.g., Micronaut’s high-level request abstraction in the abstraction layer 510. The response adapter 530 is designed to construct and represent a response object, e.g., an HTTP response object to send back to the client 550 from the application code 570, based on a network communication library 522, e.g., a “rawhttp” library, enabling integration with the modular application framework’s 500 servlet-compatible layer 560, e.g., Micronaut’s servlet-compatible HTTP layer, and encapsulates response metadata, headers, status, and body content, while providing mechanisms for response manipulation and native output extraction.

The serverless application adapter 540 is a lightweight wrapper that enables the modular application framework 500, e.g., Micronaut, to produce responses, e.g., HTTP responses, in a format compatible with network data, e.g., HTTP data (such as via the http library), such as for testing, proxying, or HTTP manipulation scenarios. Assuming an HTTP implementation, the serverless application adapter 540 emphasizes control over low-level HTTP primitives while still conforming to Micronaut’s expected response interfaces.

Thus, in one or more illustrative embodiments, assuming an HTTP implementation, the modified abstraction layer 510 of the modular application framework 500 (assumed to be the Micronaut framework) supports the constructing, managing, and emitting of HTTP response objects in a modular application, or microservice-oriented, application framework 500. The modified abstraction layer 510 operates to adapt a HTTP request stream into a structured HTTP request interface compatible with a high-level web framework. The modified abstraction layer 510 enables applications to consume HTTP request data originating from non-standard environments, such as embedded systems, network simulation tools, or test harnesses where typical servlet container APIs may be unavailable or unsuitable.

### REQUEST ADAPTER

The request adapter 520 comprises a request handler class that conforms to a standardized HTTP request interface and internally encapsulates a lower-level HTTP parser. Upon instantiation, the request adapter 520 receives an input stream representing the HTTP request data and a type conversion service configured to perform string-to-object type transformations. The request adapter 520 parses the input stream into a structured request object using the HTTP parser. This object encapsulates the method, Uniform Resource Identifier (URI), headers, and query string associated with the request. Upon successful parsing, the system initializes multiple internal components including a header accessor component and a parameter accessor component. The header accessor component is configured to extract and provide access to HTTP headers by name, and integrates with a conversion service to enable typed retrieval of header values, thereby facilitating seamless use of typed request metadata. The parameter access component parses the URI’s query string into a multi-valued map that associated each parameter name with a list of decoded string values.

The request adapter 520 exposes a set of standardized interface methods to downstream consumers. These methods allow for retrieval of the HTTP method, full URI, headers, and query parameters. The request adapter 520 assists with the modified abstraction layer 510 being particularly suited for environments requiring tight control over HTTP interactions while maintaining compatibility with higher-level request processing infrastructure. It achieves this by decoupling the parsing logic from application-level HTTP semantics and introducing a layered abstraction that can evolve independently.

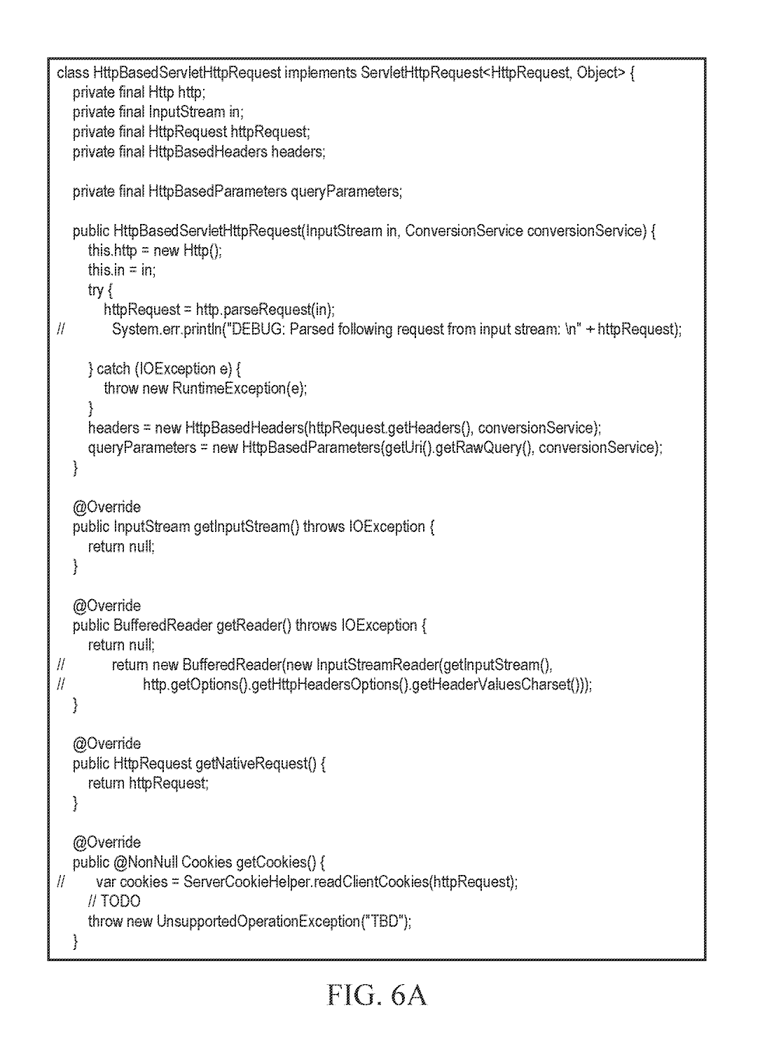

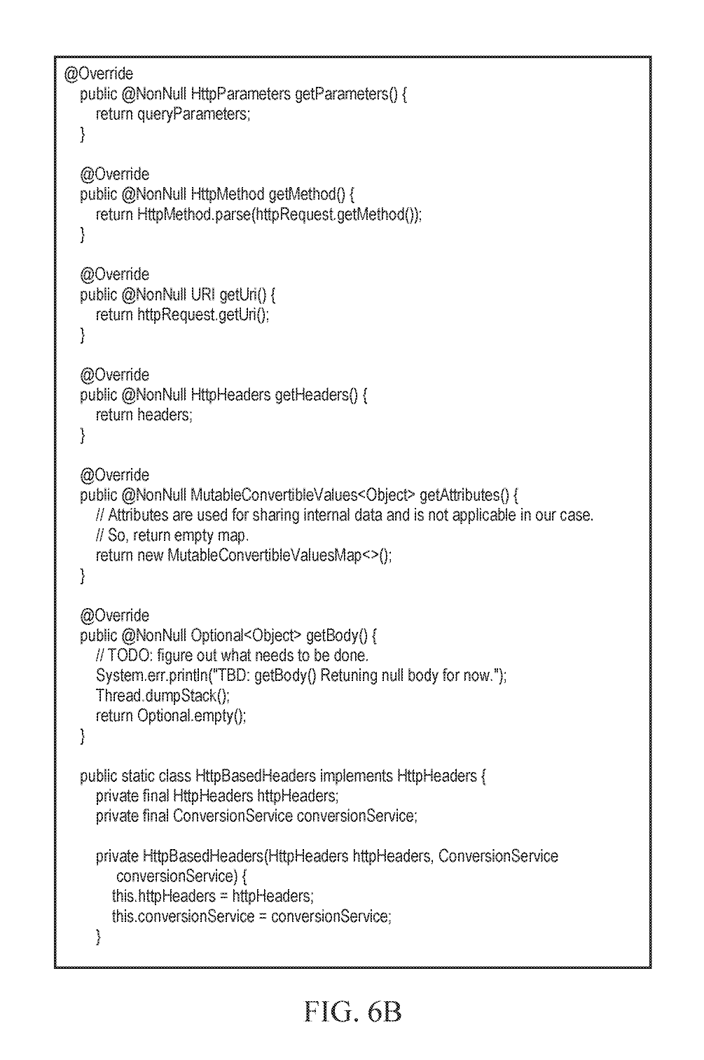

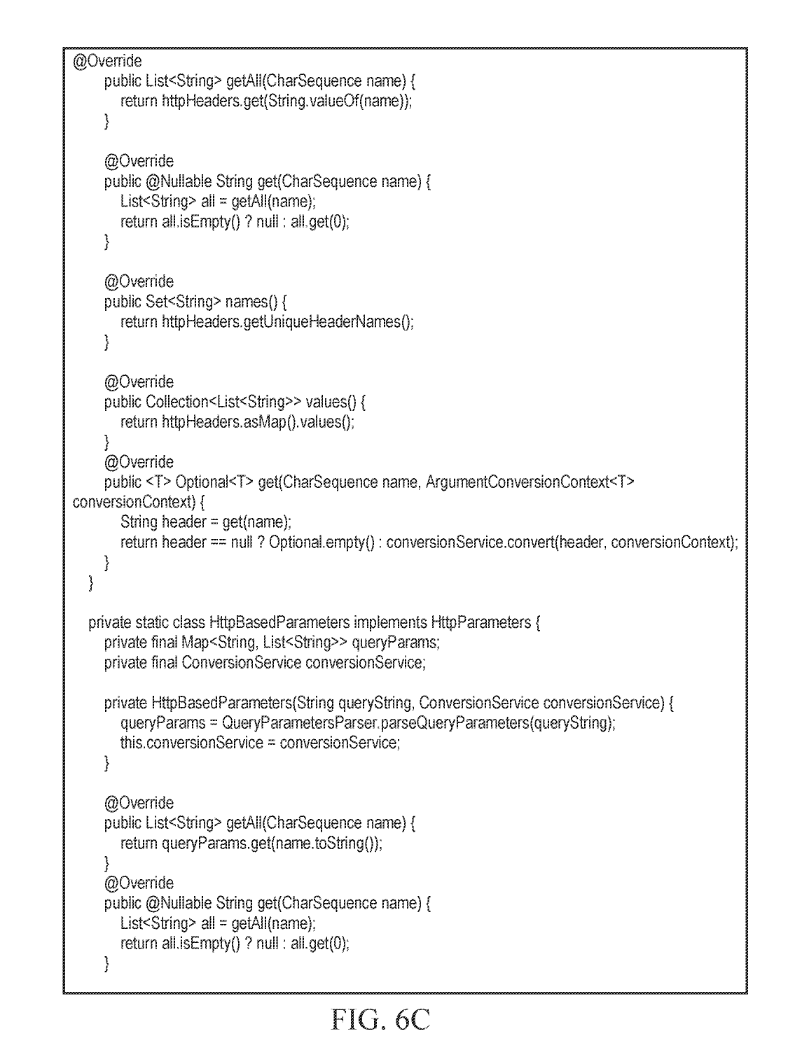

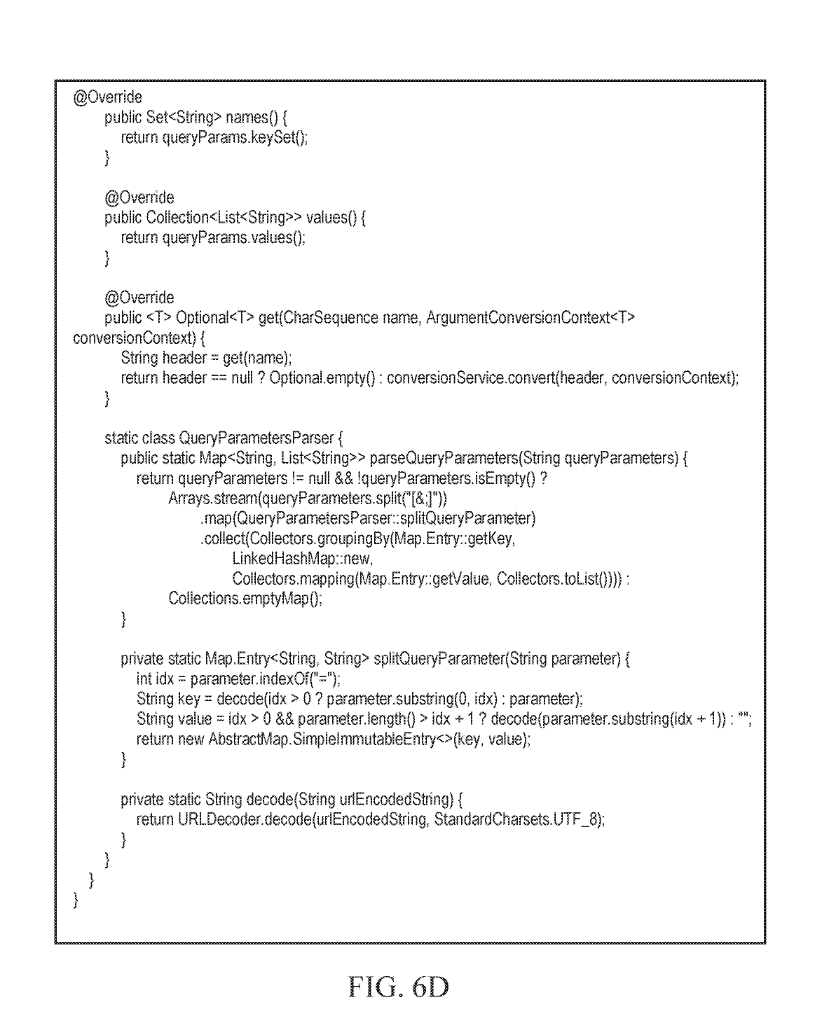

FIGS. 6A-6D are diagrams of an example portion of code for a request adapter 520 in accordance with one illustrative embodiment. The example code in FIGS. 6A-6D is Java code and is specifically for a non-limiting example implementation using Micronaut and HTTP communications. As shown in FIGS. 6A-6D, the code defines a custom HTTP request wrapper named HttpBasedServletHttpRequest, designed to adapt a low-level HttpRequest object (from the http library) into a representation that conforms to Micronaut’s ServletHttpRequest interface. The HttpBasedServletHttpRequest class acts as a bridge between HTTP request data and Micronaut’s high-level HTTP request abstraction.

When an instance of HttpBasedServletHttpRequest is created, it performs the following operations:
(1) accepts an InputStream containing the HTTP request and a ConversionService for converting request parameters;
(2) uses the Http parser to convert the raw byte stream into a structured HttpRequest object; and
(3) extracts and wraps HTTP headers and query parameters into custom inner classes (RawHttpBasedHeaders and HttpBasedParameters) for later access.

The HttpBased ServletHttpRequest class implements key methods from the ServletHttpRequest interface. For example, getNativeRequest() returns the underlying HTTP request, getMethod() returns the HTTP method (GET, POST, etc.) using Micronaut's HttpMethod type, getUri() returns the URI of the request, getParameters() returns parsed query parameters via a custom parameter parser, getHeaders() returns a wrapper around HTTP headers, enabling Micronaut-style access, and getAttributes() returns an empty map, as no internal attribute sharing is used here. The inner class HttpBasedHeaders is a Micronaut-compatible wrapper around HttpHeaders that allows access to individual or all values of a given header, header name enumeration, and conversion of header values to various types using the provided ConversionService.

The inner class HttpBasedParameters parses and stores query parameters from the request URI’s query string. The QueryParametersParser inner utility splits the query string on “&” and “;”, decodes each key-value pair, and collects the key-value pairs into a map where each key may map to multiple values. The HttpBasedParameters class provides access and conversion of these parameters similar to how headers are handled.

Thus, the request adapter 520, in accordance with the example of FIGS. 6A-6D, is a custom adapter for use cases where HTTP requests are consumed outside standard servlet containers. The request adapter 520 uses composition to cleanly isolate the logic for headers and parameters.

### RESPONSE ADAPTER

The response adapter 530 of the modified abstraction layer 510 provides a dual-purpose interface that conforms to the hosting framework’s servlet-based HTTP response abstraction and that enables low-level HTTP output compatible with HTTP libraries or tooling. The response adapter 530 may instantiate an internal binary buffer for collecting output content destined for the HTTP response body. This buffer can be implemented, for example, as a byte array-backed output stream, allowing both raw byte writing and character-based writing through an associated print or buffered writer.

At initialization, the response adapter 530 assigns default HTTP status metadata, such as a status code corresponding to HTTP 200 (OK) and an accompanying reason phrase (e.g., “OK”). The adapter also initializes a mutable HTTP header collection that is capable of storing and retrieving HTTP headers as key-value pairs, supporting both standard and custom headers. Additionally, an attribute container is provided, enabling storage of arbitrary metadata or auxiliary values associated with the response.

The response adapter 530 includes one or more interfaces for mutating the HTTP status code and associated reason phrase. When a new status is assigned, the response adapter 530 may default to a canonical reason phrase if no custom message is provided. This ensures compliance with standard HTTP semantics and provides compatibility with user agents expecting conventional status descriptors.

The response adapter 530 stores HTTP headers in a format amenable to both framework-level processing and raw transmission. The response adapter 530 may provide methods for direct header mutation as well as internal logic for transforming the framework-native headers into a format consumable by lower-level HTTP tooling.

The response adapter 530 supports output of response body content through multiple access modalities. A binary output stream interface is provided for writing raw data, such as image bytes or encoded payloads. In parallel, a character writer interface is available for scenarios requiring formatted textual output, such as HTML or JSON strings. Both interfaces write to a shared underlying buffer, ensuring consistency in body generation. The content accumulated in the output buffer is used as the response body when the response adapter 530 is requested to emit a finalized HTTP response.

A core function of the response adapter 530 is the generation of a native HTTP response object compatible with a HTTP processing library, e.g., http library. When requested, the adapter composes a response object that includes a status line, a header block, and a body reader component. The status line combines the HTTP version, status code, and reason phrase. The header block is translated from the internal header map into a format suitable for serialization. The body reader component consumes the contents of the output buffer for transmission or further processing. The emitted response object allows the modified abstraction layer 510 to interoperate with libraries or systems that expect HTTP primitives in their raw, text-based or binary serialized form.

Certain interfaces exposed by the response adapter 530 may be left intentionally unimplemented or may function as no-ops, depending on system requirements. For example, cookie-setting functionality may be stubbed to conform to interface requirements without altering the response state. Similarly, some body-setting interfaces may throw runtime exceptions if body content is intended to be written exclusively via output streams rather than via assignment.

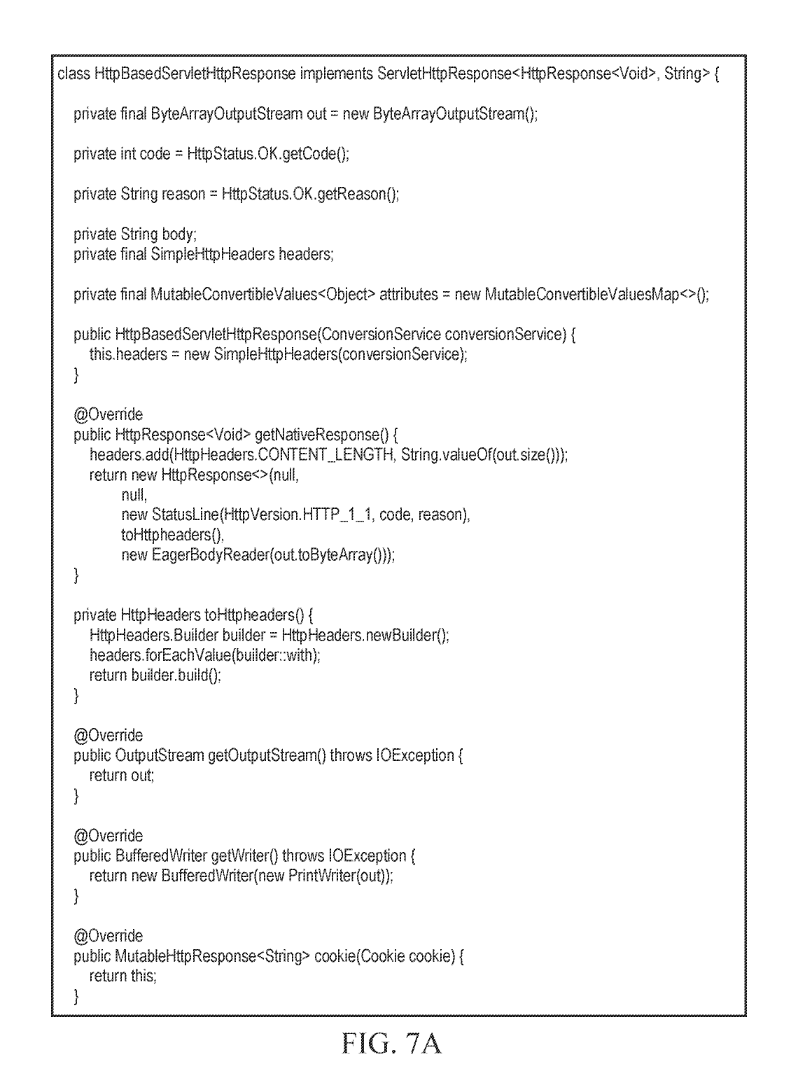

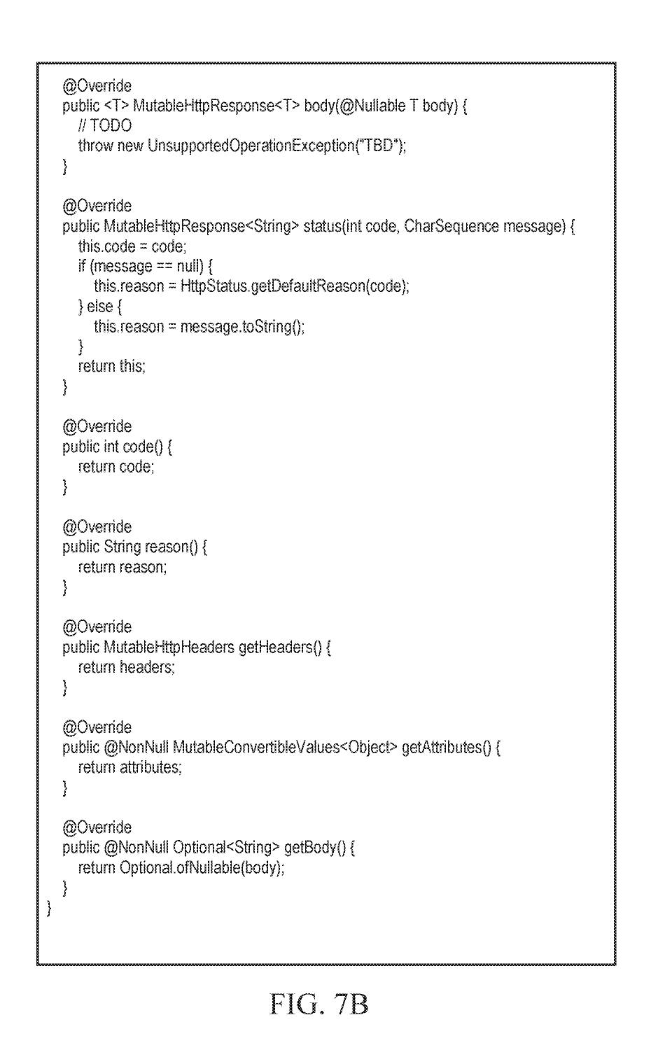

FIGS. 7A-7B are diagrams of an example portion of code for a response adapter 530 in accordance with one illustrative embodiment. The example code in FIGS. 7A-7B is Java code and is specifically for a non-limiting example implementation using Micronaut and HTTP communications. As shown in FIGS. 7A-7B, the code defines a Java class, HttpBasedServletHttpResponse, which serves as an adapter that allows the Micronaut framework to bridge its HTTP response abstraction with the lower-level HttpResponse type from the http library. The HttpBasedServletHttpResponse class is designed to construct and represent an HTTP response object based on the http library, enabling integration with Micronaut’s servlet-compatible HTTP layer. It encapsulates HTTP response metadata, headers, status, and body content, while providing mechanisms for response manipulation and native output extraction.

At a high level, the HttpBasedServletHttpResponse class (referred to herein as the “Response” class for simplicity) performs internal output handling, status and reason tracking, header management, attribute storage, native response construction, and stream and writer access. With regard to internal output handling, the Response class uses a ByteArrayOutputStream (out) as the internal buffer for writing the response body content. This output stream collects the response payload that may later be converted into a HTTP response body.

With regard to status and reason tracking, the Response class initializes the response status to HTTP 200 (OK), and both the numeric code and textual reason phrase are tracked separately (code and reason). Regarding header management, the Response class manages HTTP headers using a SimpleHttpHeaders instance, which itself supports mutation and conversion operations via Micronaut’s ConversionService. With regard to attribute storage, the Response class associates arbitrary attributes with the response, which are stored in a MutableConvertibleValuesMap. These values can be used for custom metadata or stateful response handling in the Micronaut framework.

With regard to native response construction, the Response class implements the getNativeResponse() method which creates a HttpResponse<Void> object, composed of a status line derived from the current HTTP version, response code, and reason phrase, headers converted from Micronaut’s internal format into HttpHeaders, and a body constructed from the current byte stream content via EagerBodyReader.

Regarding header conversion logic, the Response class implements the toRawHttpheaders() helper method which builds HttpHeaders by iterating over the internal header structure and converting each entry into the HTTP format. With regard to stream and writer access, the Response class provides both binary output (OutputStream) and character stream output (BufferedWriter) interfaces for writing to the response body. These write directly to the internal ByteArrayOutputStream.

The status(int code, CharSequence message) method allows mutation of the HTTP status. If no reason phrase is supplied, it uses Micronaut’s default reason phrase lookup. Methods such as code(), reason(), getHeaders(), and getAttributes() provide access to the internal state and allow the Micronaut framework or other components to introspect the response. The getBody() method returns the response body, if available.

Thus, the response adapter 530 provides a lightweight wrapper that enables Micronaut to produce HTTP responses in a format compatible with http. It emphasizes control over low-level HTTP primitives while still conforming to Micronaut’s expected response interfaces.

### SERVERLESS APPLICATION ADAPTER

As mentioned above, the serverless application adapter 540 is a lightweight wrapper that enables the modular application framework 500 to produce responses in a format compatible with network data. As discussed above, conventional web applications often rely on managed server environments to handle HTTP request routing and lifecycle management. In contrast, serverless computing models require lightweight, stateless components that can interact with system input and output streams directly, without assuming the presence of a dedicated servlet container or persistent HTTP server. The serverless application adapter 540 provides the abstraction layer 510 of the modular application framework 500 with the capability to implement a serverless HTTP application execution engine. The serverless application adapter 540 is configured to continuously receive, parse, process, and respond to network requests, e.g., HTTP requests, over standard input and output channels (STDIN/STDOUT), leveraging the modular application framework and stream-based input/output interfaces.

The serverless application adapter 540 may comprise a class, referred to herein as ServerlessApplication, which encapsulates the lifecycle, configuration, and request handling logic of an embedded HTTP application operating in a serverless mode. The serverless application adapter 540 comprises an application context module, a configuration interface, a servlet HTTP handler, and a conversion service module. The application context module is an instantiable context object configured to manage dependency injection, configuration binding, and lifecycle state for application components. The configuration interface provides a functionality to retrieve application-specific settings used during runtime execution. The servlet HTTP handler, when instantiate, operates to conform to servlet request-response handling semantics and is subclassed to disable certain default behaviors, e.g., exchange creation, that are incompatible with serverless modes of operation. The conversion service module is a type conversion utility that is used to mediate between streamed input and structured application-level request and response objects.

Upon invocation of the start method of the serverless application adapter 540, the conversion service and HTTP handler are instantntiated and an attempt is made to obtain an inherited system channel. If successful, the channel is converted into input and output streams. Otherwise, if not successful, the serverless application adapter 540 defaults to using the standard input/output streams (STDIN or “system.in” and STDOUT or “system.out”).

Thereafter, a continuous execution loop is entered where the following operations are performed. A servlet exchange object is constructed for each iteration, where the servlet exchange object comprises a request component that reads and interprets a HTTP request from the input stream, and a response component that collects output data for serialization back to the client, i.e., the request adapter 520 and response adapter 530 may be these components, respectively. The servlet exchange is passed to the HTTP handlers’ service() method, which performs routing, processing, and response generation. Upon completion of the request handling, the HTTP response is written to the output stream using a standard serialization routine.

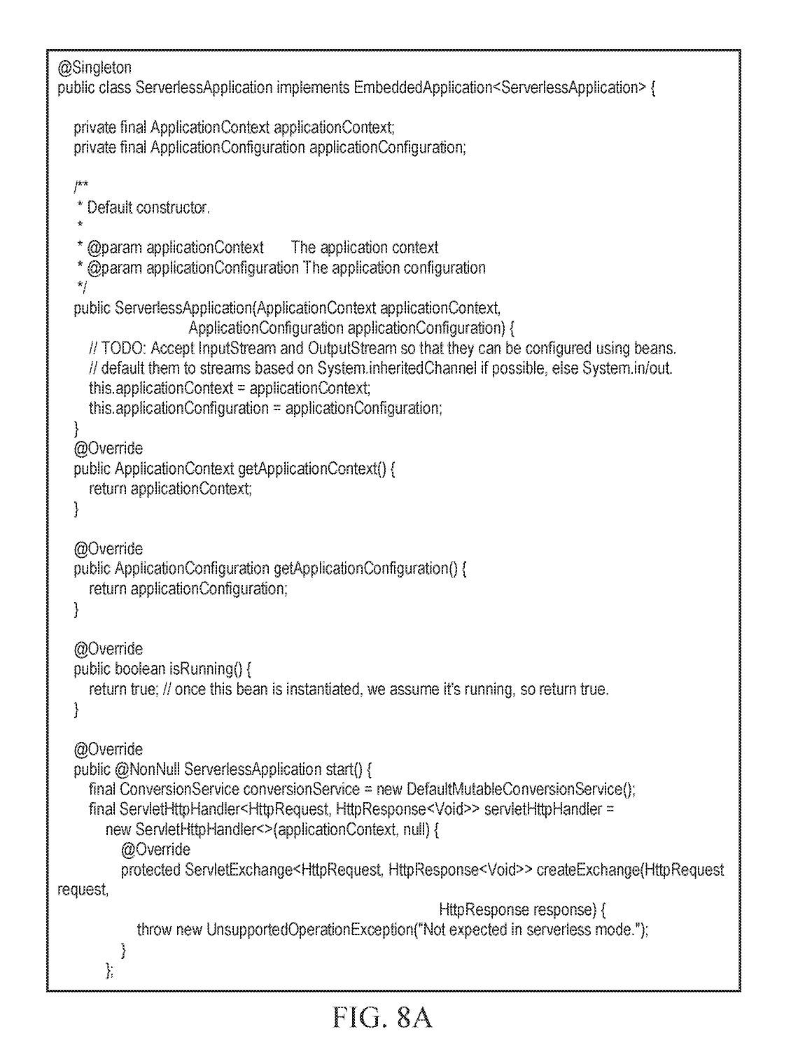

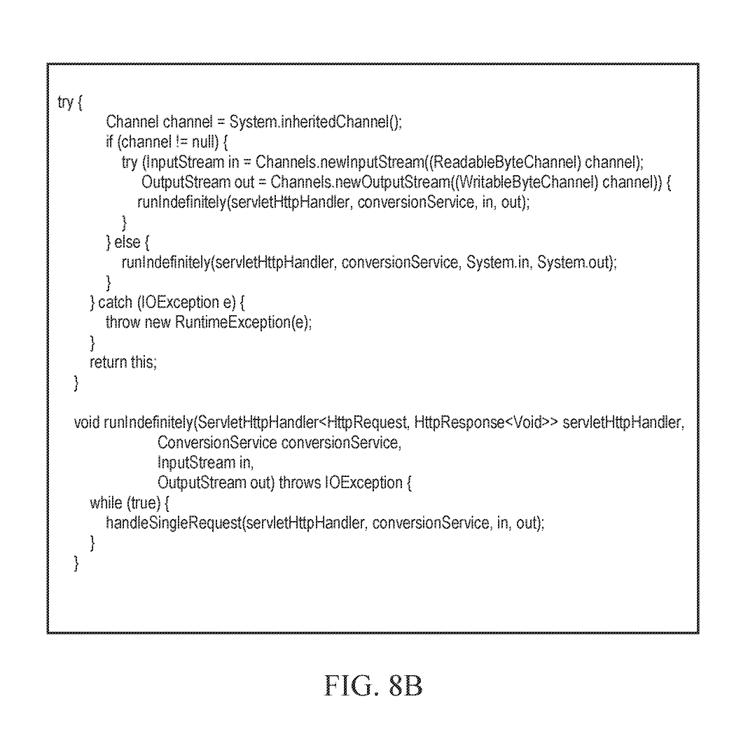

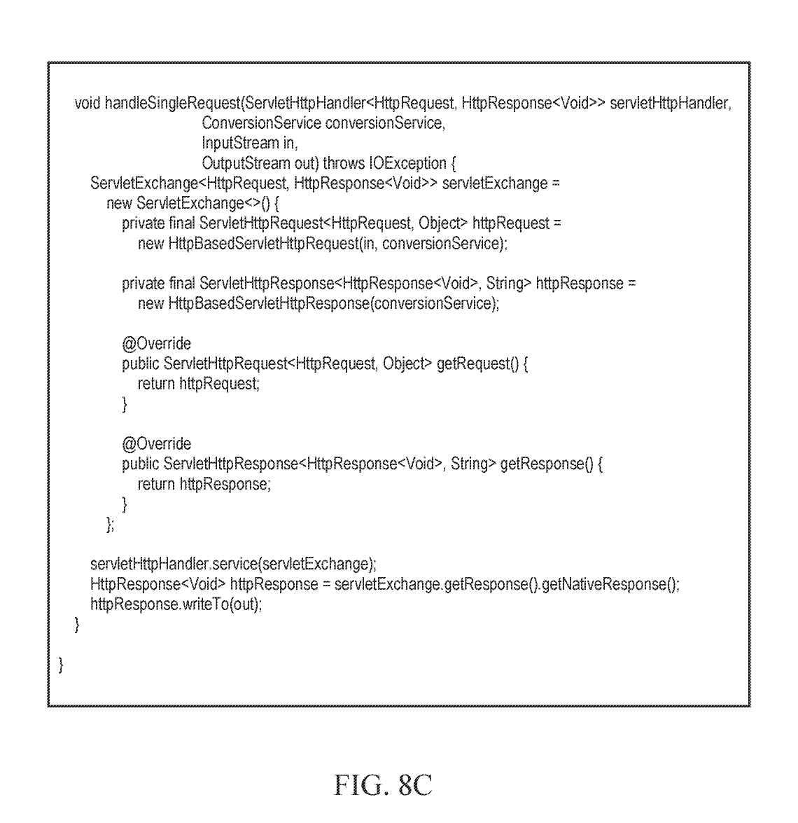

FIGS. 8A-8C are diagrams of an example portion of code for a serverless application adapter 540 in accordance with one illustrative embodiment. The example code in FIGS. 8A-8C is Java code and is specifically for a non-limiting example implementation using Micronaut and HTTP communications. As shown in FIGS. 8A-8C, the code implements a serverless web application handler that is designed to operate in a POSIX-compatible, serverless execution environment using the Micronaut framework. The serverless application adapter 540 implements a ServerlessApplication class and an EmbeddedApplication interface, which together represent a self-contained runtime application. Some key components include application context and configuration, and lifecycle management. With regard to application context and configuration, the serverless application adapter 540 accepts two principal objects during initialization: an ApplicationContext, which provides runtime dependency injection and bean management, and an ApplicationConfiguration, which supplies application-specific configuration settings. With regard to lifecycle management, the serverless application adapter 540 overrides standard methods, such as getApplicationContext(), getApplicationConfiguration(), isRunning(), and start(). Notably, the isRunning() method returns true, indicating that once the object is instantiated, the application is considered active.

Looking at the core logic and execution flow in the depicted example of FIGS. 8A-8C, at startup, the serverless application adapter 540 instantiates a conversion service and a ServletHttpHandler, which is a central dispatch mechanism for handling HTTP requests and responses. The ServletHttpHandler is subclassed with an overridden method createExchange(...) that throws an exception. This enforces that traditional servlet exchange creation is disallowed in this serverless mode, which highlights the serverless application adapter’s 540 serverless constraint.

The start() method attempts to retrieve a communication channel via System.inheritedChannel(). This allows the serverless application adapter 540 to integrate with the standard POSIX-style I/O channels, which is useful for environments like AWS Lambda or other function-as-a-service (FaaS) platforms. If a channel is available, it is wrapped into input and output streams; otherwise, it falls back to using the standard input/output streams (STDIN or “system.in” and STDOUT or “system.out”). This flexible fallback ensures compatibility across different runtime environments.

Thereafter the serverless application adapter 540 enters an loop, repeatedly invoking handleSingleRequest(...). This reflects a continuous processing of input requests and generating corresponding responses, which emulates the behavior of a persistent request processor within a stateless environment. With regard to request processing (handleSingleRequest), within each iteration, a ServletExchange is created using two helper classes referenced in the code as: HttpBasedServletHttpRequest which parses an incoming HTTP request from the input stream, and HttpBasedServletHttpResponse which prepares a response object to hold the outbound HTTP data. These are passed to the ServletHttpHandler.service(...) method, which orchestrates the request-response cycle. Once processed, the resulting HttpResponse is written to the output stream, effectively completing the HTTP response cycle.

From FIGS. 8A-8C it can be seen that this code exemplifies a lightweight, embeddable HTTP application environment, intended for event-driven, serverless execution platforms. The design of the serverless application adapter 540 explicitly avoids standard servlet container behavior and instead simulates servlet interactions using input/output streams (e.g., STDIN and STDIOUT). The use of the loop and direct stream I/O provides a runtime model aligned with low-latency, synchronous processing of serialized HTTP traffic, such as in containerless microservices architectures. By abstracting the request handling and conversion logic, the codebase is portable across a variety of deployment models without being tied to heavyweight application servers.

Thus, in accordance with one or more illustrative embodiments, a modified abstraction layer for the modular application framework is provided that implements a modular, lightweight architecture for executing network, or web, applications in environments where traditional servlet containers are unavailable or undesirable. By directly interfacing with system-level I/O channels and abstracting request parsing and response handling through a consistent framework, the illustrative embodiments enable scalable and portable network communication based, e.g., HTTP-based, application execution in serverless platforms, including but not limited to containerized or cloud-based runtimes.

### HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

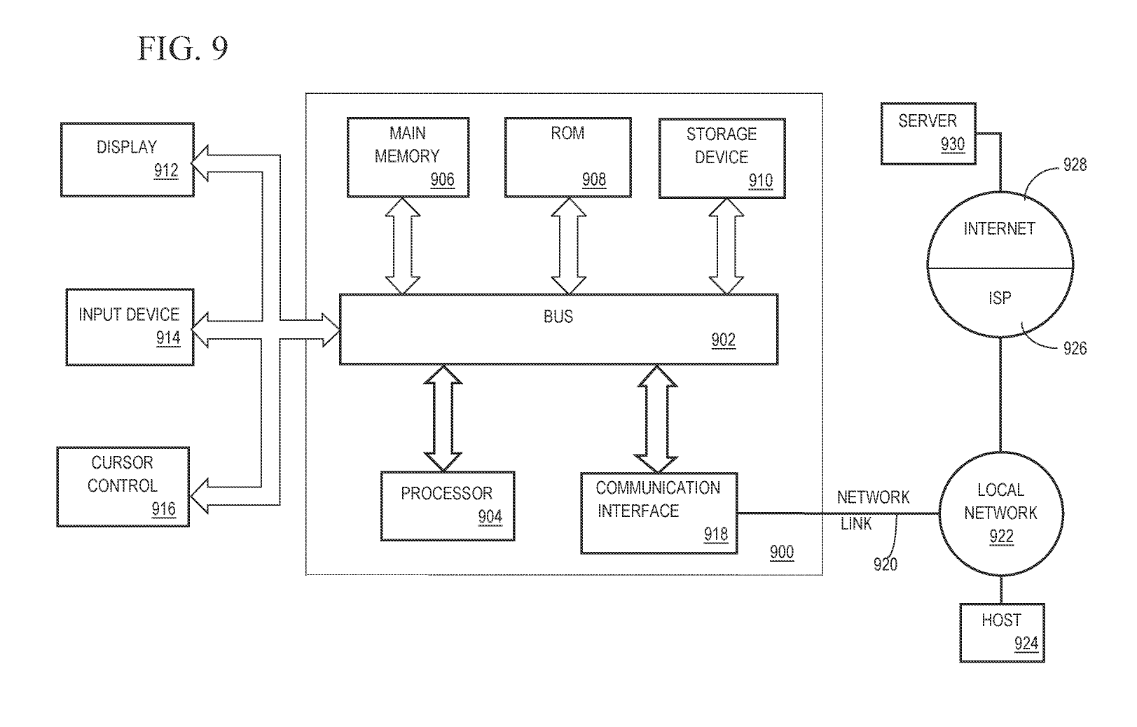

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### SOFTWARE OVERVIEW

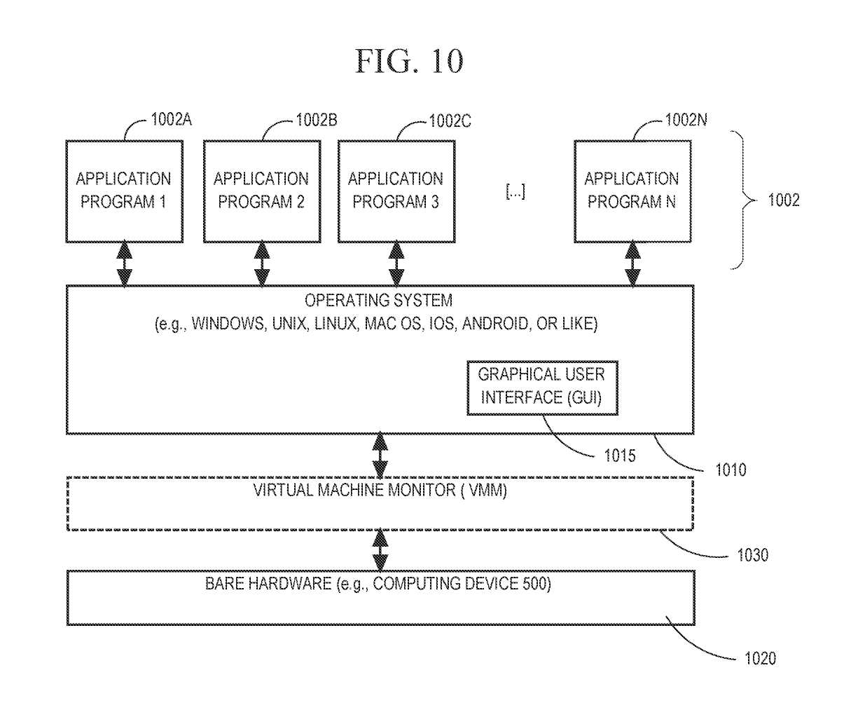

FIG. 10 is a block diagram of a basic software system 1000 that may be employed for controlling the operation of computer system 900 upon which aspects of the illustrative embodiments may be implemented. Software system 1000 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computer system 900. Software system 1000, which may be stored in system memory (RAM) 906 and on fixed storage (e.g., hard disk or flash memory) 910, includes a kernel or operating system (OS) 1010.

The OS 1010 manages low-level aspects of computer operation, including managing execution of processes, memory allocation, file input and output (I/O), and device I/O. One or more application programs, represented as 1002A, 1002B, 1002C… 1002N, may be “loaded” (e.g., transferred from fixed storage 910 into memory 906) for execution by the system 1000. The applications or other software intended for use on computer system 900 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 904) of computer system 900. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 900.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system to run as if it is running on the bare hardware 1020 of computer system 900 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### CLOUD COMPUTING

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
executing, in a modular application framework comprising an abstraction layer that abstracts network servers from application code, a request adapter that bridges network request data targeting a target application, and a network request abstraction of the abstraction layer of the modular application framework;
executing, in a modular application framework, a response adapter that generates a response object based on a network communication library and enabling integration with a servlet-compatible layer of the modular application framework;
executing, in the modular application framework, a serverless application adapter that provides a wrapper enabling the modular application framework to produce responses to requests in a format compatible with network data;
processing a request, from a client targeting the target application, via the serverless application adapter and request adapter; and
processing a response from the target application via the serverless application adapter and response adapter.

2. The method of claim 1, wherein the request adapter operates to process the request by communicating the request to the target application via a standard input (STDIN) stream of the target application, and wherein the response adapter operates to process the response from the target application via a standard output (STDOUT) stream of the target application.

3. The method of claim 1, wherein the request adapter comprises a request handler class that conforms a standardized network request interface to downstream consumers and encapsulates a low-level network data parser that parses an input stream into a structured request object for a request which encapsulates the method, uniform resource identifier (URI), headers, and query string associated with the request.

4. The method of claim 1, wherein the request adapter processes the request at least by:
accepting an input of a byte stream and executing a conversion service for converting request parameters;
executing a network data parser to convert the byte stream to a structured request object; and
extracts and wraps header and query parameters into customer inner classes for later access.

5. The method of claim 1, wherein processing the response via the response adapter comprises:
assigning a status code and accompanying reason phrase metadata to the response;
storing headers in a format corresponding to the modular application framework; and
generating response body content by executing at least one of a response data writer or character writer interface using a shared buffer.

6. The method of claim 5, wherein storing headers comprises translating headers from an internal header map into a format suitable for serialization, and wherein the response body content is generated by reading the contents from the output buffer in response to a request to emit the response.

7. The method of claim 1, wherein the serverless application adapter comprises:
an application context module that is an instantiable context object configured to manage dependency injection, configuration binding, and lifecycle state for application components;
a configuration interface that provides a functionality to retrieve application-specific settings used during runtime execution;
a servlet handler that operates to conform to servlet request-response handling semantics; and
a conversion service utility that mediates between stream input and structured application-level request and response objects.

8. The method of claim 1, wherein the modular application framework is Micronaut, and wherein the requests are HyperText Transport Protocol (HTTP) requests.

9. The method of claim 1, wherein processing the request further comprises:
initializing an application instance of the target application in an execution runtime;
configuring, for the application instance, a mapping of a network communication channel over which the request was received, to a standard input stream and standard output stream of application code of the target application; and
executing the application instance in the execution runtime, wherein subsequent requests to the application instance received via the network communication channel are mapped to the standard input stream and responses from the application instance are mapped to the standard output stream for transmission over the network communication channel, and wherein the application code of the target application is configured to check the standard input stream continuously while the network communication channel is active.

10. The method of claim 9, wherein the standard input stream is the STDIN stream having file descriptor 0 (FD0), and wherein the standard output stream is the STDIN stream having file descriptor 1 (FD1).

11. The method of claim 9, wherein the target application is a serverless application whose application code does not include code for implementing a server and does not include code for supporting socket-based communications.

12. The method of claim 9, wherein the request is received at a tinyinit engine associated with the target application, and wherein initializing the application instance comprises the tinyinit engine forking a virtual hypervisor and loading an application image of the application into an isolated memory region to generate the application instance.

13. The method of claim 12, wherein initializing the application instance further comprises passing, by the tinyinit engine, the network communication channel to the virtual hypervisor and application instance as file descriptors.

14. One or more non-transitory computer-readable media storing instructions which, when executed by one or more processors, cause performance of:
executing, in a modular application framework comprising an abstraction layer that abstracts network servers from application code, a request adapter that bridges network request data targeting a target application, and a network request abstraction of the abstraction layer of the modular application framework;
executing, in a modular application framework, a response adapter that generates a response object based on a network communication library and enabling integration with a servlet-compatible layer of the modular application framework;
executing, in the modular application framework, a serverless application adapter that provides a wrapper enabling the modular application framework to produce responses to requests in a format compatible with network data;
processing a request, from a client targeting the target application, via the serverless application adapter and request adapter; and
processing a response from the target application via the serverless application adapter and response adapter.

15. The one or more non-transitory computer-readable media of claim 14, wherein the request adapter operates to process the request by communicating the request to the target application via a standard input (STDIN) stream of the target application, and wherein the response adapter operates to process the response from the target application via a standard output (STDOUT) stream of the target application.

16. The one or more non-transitory computer-readable media of claim 14, wherein the request adapter comprises a request handler class that conforms a standardized network request interface to downstream consumers and encapsulates a low-level network data parser that parses an input stream into a structured request object for a request which encapsulates the method, uniform resource identifier (URI), headers, and query string associated with the request.

17. The one or more non-transitory computer-readable media of claim 14, wherein the request adapter processes the request at least by:
accepting an input of a byte stream and executing a conversion service for converting request parameters;
executing a network data parser to convert the byte stream to a structured request object; and
extracts and wraps header and query parameters into customer inner classes for later access.

18. The one or more non-transitory computer-readable media of claim 14, wherein processing the response via the response adapter comprises:
assigning a status code and accompanying reason phrase metadata to the response;
storing headers in a format corresponding to the modular application framework; and
generating response body content by executing at least one of a response data writer or character writer interface using a shared buffer, wherein storing headers comprises translating headers from an internal header map into a format suitable for serialization, and wherein the response body content is generated by reading the contents from the output buffer in response to a request to emit the response.

19. The one or more non-transitory computer-readable media of claim 14, wherein the serverless application adapter comprises:
an application context module that is an instantiable context object configured to manage dependency injection, configuration binding, and lifecycle state for application components;
a configuration interface that provides a functionality to retrieve application-specific settings used during runtime execution;
a servlet handler that operates to conform to servlet request-response handling semantics; and
a conversion service utility that mediates between stream input and structured application-level request and response objects.

20. An apparatus, comprising:
a processor; and
a memory coupled to the processor, wherein the memory comprises instructions which, when executed by the processor, cause the processor to execute the process comprising:
executing, in a modular application framework comprising an abstraction layer that abstracts network servers from application code, a request adapter that bridges network request data targeting a target application, and a network request abstraction of the abstraction layer of the modular application framework;
executing, in a modular application framework, a response adapter that generates a response object based on a network communication library and enabling integration with a servlet-compatible layer of the modular application framework;
executing, in the modular application framework, a serverless application adapter that provides a wrapper enabling the modular application framework to produce responses to requests in a format compatible with network data;
processing a request, from a client targeting the target application, via the serverless application adapter and request adapter; and
processing a response from the target application via the serverless application adapter
and response adapter.
